(19) United States
(12) Patent Application Publication
(10) Pub. No.: US 2009/0108536 A1
(43) Pub. Date: Apr. 30, 2009

(54) Actuator Seal

(75) Inventor: Kane A. Myers, Indianapolis, IN (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/930,235

(22) Filed: Oct. 31, 2007

(51) Int. Cl. F16J 15/00

(52) U.S. Cl. 277/549

(57) ABSTRACT

A seal is provided for sealing between an outer perimeter opening having upper and lower edges and an inner assembly having first and second members. The seal includes an outer perimeter seal including a reinforcing insert molded therein. The outer perimeter seal includes a first seal bead at a first axial end and a second seal bead at a second axial end. A flexible diaphragm portion extends radially inward from the outer perimeter seal. An inner perimeter seal is connected to a radially inner end of the flexible diaphragm portion. The inner perimeter seal includes a first seal bead on a first surface of the inner perimeter seal and a second seal bead on a second surface of the inner perimeter seal. The inner perimeter seal being adapted to be inserted between the first and second members of the inner assembly.

### FIELD

The present disclosure relates to seals and more particularly, to a hand assemblable actuator seal.

### BACKGROUND AND SUMMARY

The statements in this section merely provide background information related to the present disclosure and may not constitute prior art.

Providing a seal between an outer perimeter opening and an inner member spaced radially inward from the outer perimeter opening presents design challenges.

The present disclosure provides a seal for sealing between an outer perimeter opening having upper and lower edges and an inner assembly having first and second members. The seal includes an outer perimeter seal including a reinforcing insert molded therein. The outer perimeter seal includes a first seal bead at a first axial end and a second seal bead at a second axial end. A flexible diaphragm portion extends radially inward from the outer perimeter seal. An inner perimeter seal is connected to a radially inner end of the flexible diaphragm portion. The inner perimeter seal includes a first seal bead on a first surface of the inner perimeter seal and a second seal bead on a second surface of the inner perimeter seal. The inner perimeter seal being adapted to be inserted between the first and second members of the inner assembly.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross-sectional view illustrating the actuator seal in an assembled condition according the principles of the present disclosure;

FIG. 2 is a perspective view of the actuator seal shown in FIG. 1;

FIG. 3 is a cross-sectional view taken along line 3-3 of FIG. 2;

FIG. 4 is a cross-sectional view taken along line 4-4 of FIG. 2;

FIG. 5 is a cross-sectional view of an alternative actuator seal in an assembled condition according to the principles of the present disclosure;

FIG. 6 is a perspective view of the actuator seal of FIG. 5;

FIG. 7 is a cross-sectional view taken along line 7-7 of FIG. 6;

FIG. 8 is a cross-sectional view taken along 8-8 of FIG. 67;

FIG. 9 is a cross-sectional view of an alternative actuator seal in an assembled condition;

FIG. 10 is a perspective view of the actuator seal of FIG. 9;

FIG. 11 is a cross-sectional view taken along line 11-11 of FIG. 10.

### DETAILED DESCRIPTION

The following description is merely exemplary in nature and is not intended to limit the present disclosure, application, or uses. It should be understood that throughout the drawings, corresponding reference numerals indicate like or corresponding parts and features.

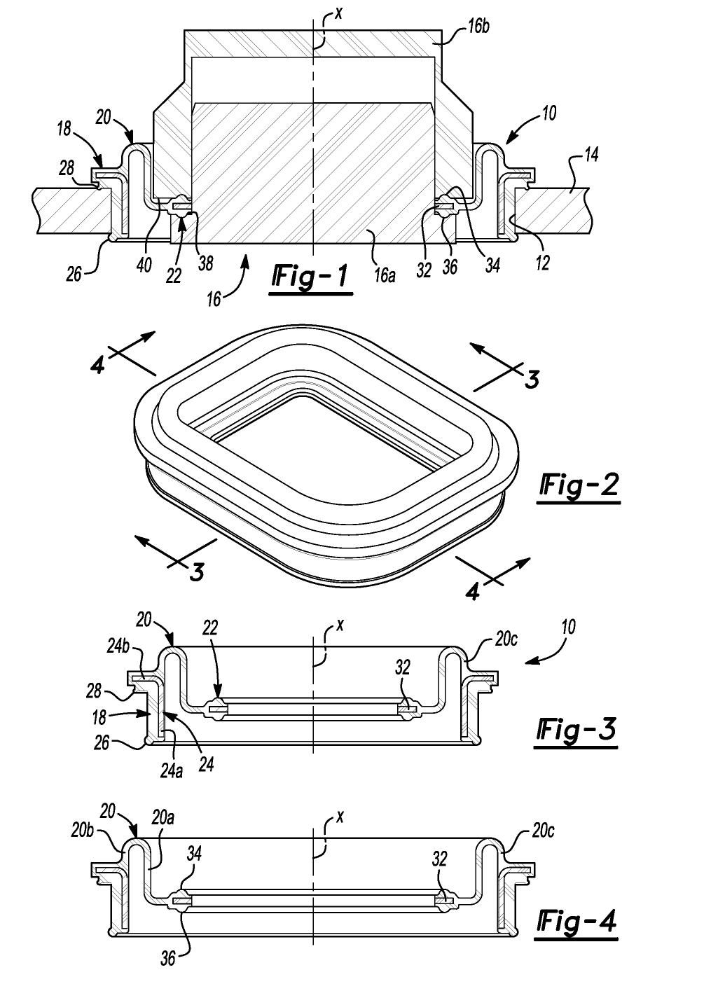

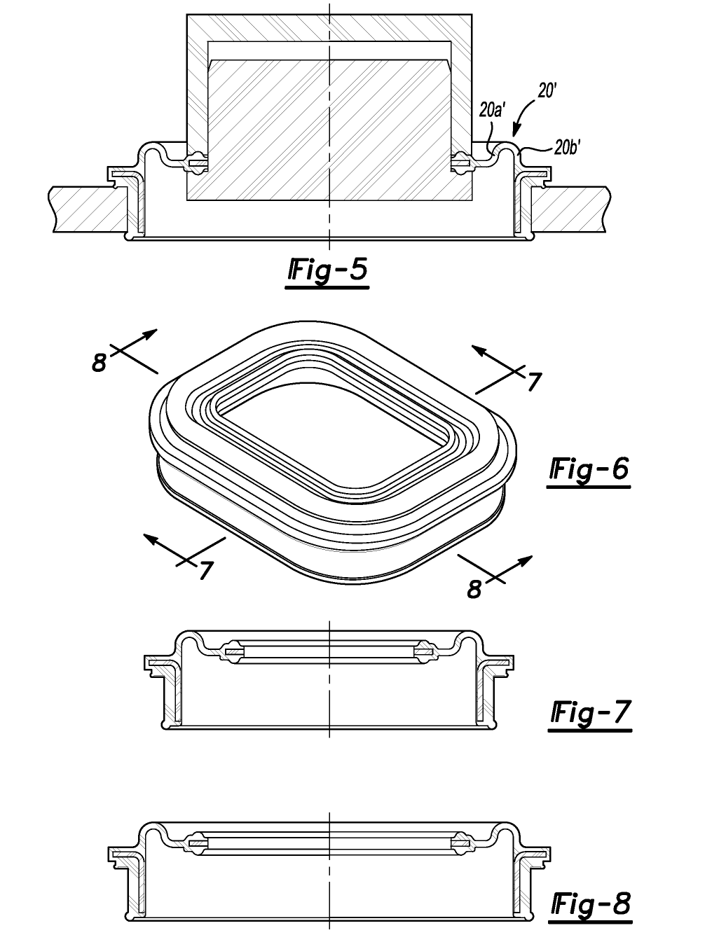

With reference to FIGS. 1-4, an actuator seal 10 according to the principles of the present disclosure will now be described. The actuator seal 10 is provided for connection between an outer perimeter opening 12 in an outer member 14 and an inner member 16 spaced radially inward from the outer perimeter opening 12. The actuator seal 10 includes an outer perimeter seal 18, a flexible diaphragm portion 20 extending radially inwardly from the outer perimeter seal 18 and a inner perimeter seal 22 extending from the flexible diaphragm portion 20.

The outer perimeter seal 18 includes a reinforcing insert 24 molded therein. The reinforcing insert 24 generally has a shape of the outer perimeter opening 12 and includes an axial wall portion 24a extending perpendicular to a central axis X of the outer perimeter seal 18. A radially outwardly extending flange 24b extends generally perpendicularly from an end of the axial wall portion 24a. The outer perimeter seal 18 includes a first seal bead 26 at a first axial end thereof and a second seal bead 28 at a second axial end thereof. The first seal bead 26 is designed to be inserted through the opening 12 in the outer member 14 and to engage a lower edge thereof in its assembled condition as shown in FIG. 1. The second seal bead 28 is designed to be disposed against an upper surface of the outer member 14 as illustrated in FIG. 1. The opening 12 in the outer member 14 can be provided with a tapered upper surface for easily accommodating the first seal bead 26 during insertion of the outer perimeter seal 18 into the opening 12. The tapered portion allows the first seal bead to be deformed inward while the outer perimeter seal 18 is slid into the opening 12 until the bead 26 clears the bottom edge of the opening and can expand outward to lock the outer perimeter seal 18 in place within the opening 12. The radially outwardly extending flange 24b of the reinforcing insert 24 overlaps the upper surface of the outer member 14 in order to prevent the outer perimeter seal 18 from being pushed through the opening 12.

The inner perimeter seal 22 includes a reinforcing insert 32 generally having a shape corresponding to a perimeter shape of the inner member 16. The reinforcing member can be formed from a flat plate and can be molded into the inner perimeter seal 22. The inner perimeter seal 22 includes an upper bead 34 and a lower bead 36 on upper and lower surfaces of the inner perimeter seal 32, respectively.

The inner perimeter seal 22 is designed to seal against an upper surface 38 of a lower component 16a of the inner assembly 16 as well as against a lower surface 40 of an upper component 16b of the inner assembly 16.

The flexible diaphragm portion 20 extending between the outer perimeter seal 18 and the inner perimeter seal 22 can extend axially from the outer perimeter seal portion at the end including the radial flange portion 24b of the reinforcing insert 24. The flexible diaphragm portion 20 can include a folded-over portion such that the flexible diaphragm portion radially overlaps itself with an inner arm portion 20a, an outer arm portion 20b, and an arcuate connecting portion 20c while extending radially inward between the outer perimeter seal 18 and the inner perimeter seal 22.

As seen in FIG. 2, the seal 10 can have a generally rectangular shape for sealing a generally rectangular opening in the outer member and a generally rectangular inner member. The length of the flexible diaphragm portion can be provided to allow variance in the positioning between the inner member 16 and the outer member 14 without providing strain on the seal 10. As illustrated in FIGS. 1-4, the flexible diaphragm portion 20 includes a relatively long inner arm portion 20a and a relatively shorter outer arm portion 20b. The length of the inner arm portion 20a and outer arm portion 20b can be varied depending on a specific application. As shown in the embodiments illustrated in FIGS. 5-8, a relatively short inner and outer arm portions 20a′, 20b′ are provided in an application where less variation of the position of the inner member 16 relative to the outer member 14 is required.

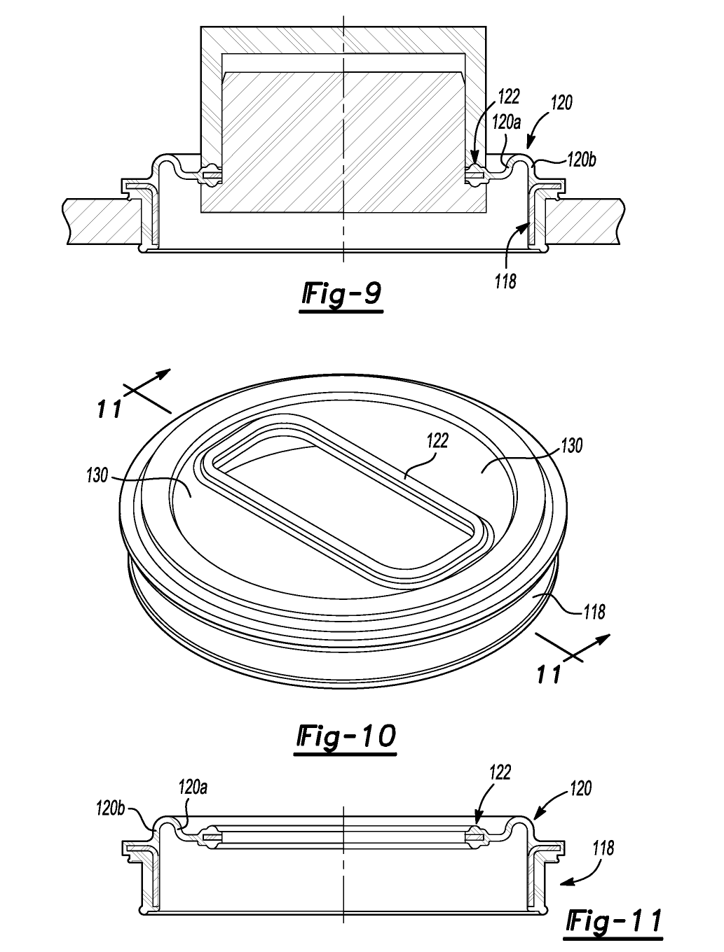

Although the exemplary embodiments of FIGS. 1-8 illustrate a generally rectangular seal 10, the seal can also be provided with other shapes such as square, oval, circular and other desired shapes. In the embodiment illustrated in FIGS. 9-11, a seal 110 according to the principles of the present disclosure is shown including a circular outer perimeter seal 118 and a rectangular inner perimeter seal 122 which are constructed similar to the outer perimeter seal 18 and inner perimeter seal 22 as described herein as detailed above. The flexible diaphragm portion 120 of the seal 110 is provided with transition areas 130 which can be generally planar and transition from the flexible inner arm portion 120a to the inner perimeter seal 122.

What is claimed is:

1. A seal for sealing between an outer perimeter opening having upper and lower edges and an inner assembly having first and second members, comprising:
an outer perimeter seal including a reinforcing insert molded therein, said reinforcing insert generally having a shape of the outer perimeter opening and including an axial wall portion extending perpendicular to a central axis of said outer perimeter seal and a radially outwardly extending flange portion extending from one end of said axial wall portion, said outer perimeter seal including a first seal bead at a first axial end of said reinforcing insert and a second seal bead at a second axial end of said reinforcing insert;
a flexible diaphragm portion extending radially inward from said outer perimeter seal; and
an inner perimeter seal connected to a radially inner end of said flexible diaphragm portion, said inner perimeter seal including a reinforcing insert therein and a first seal bead on a first surface of said inner perimeter seal and a second seal bead on a second surface of said inner perimeter seal, said second surface facing in a direction opposite to said first surface, said inner perimeter seal being adapted to be inserted between the first and second members of the inner assembly.

2. The seal according to claim 1, wherein said outer perimeter seal is circular.

3. The seal according to claim 2, wherein said inner perimeter seal is rectangular.

4. The seal according to claim 1, wherein said inner perimeter seal is rectangular.

5. The seal according to claim 1, wherein said outer perimeter seal is generally rectangular.

6. The seal according to claim 5, wherein said inner perimeter seal is generally rectangular.

7. The seal according to claim 1, wherein said first seal bead of said outer perimeter seal extends radially outward.

8. The seal according to claim 7, wherein said second seal bead of said outer perimeter seal extends radially outward.

9. The seal according to claim 7, wherein said second seal bead of said outer perimeter seal extends axially in a direction of said first seal bead.

10. The seal according to claim 1, wherein said reinforcing insert of said inner perimeter seal is molded into said inner perimeter seal.

11. The seal according to claim 1, wherein said flexible diaphragm portion extends axially from said reinforcing insert of said outer perimeter seal.

12. The seal according to claim 11, wherein said flexible diaphragm portion forms a fold-over portion wherein said flexible diaphragm portion radially overlaps itself between said outer perimeter seal and said inner perimeter seal.

13. A seal for sealing between an outer perimeter opening having upper and lower edges and an inner assembly having first and second members, comprising:
an outer perimeter seal including a reinforcing insert molded therein, said reinforcing insert generally having a shape of the outer perimeter opening, said outer perimeter seal including a first seal bead at a first axial end and a second seal bead at a second axial end;
a flexible diaphragm portion extending radially inward from said outer perimeter seal; and
an inner perimeter seal connected to a radially inner end of said flexible diaphragm portion, said inner perimeter seal including a first seal bead on a first surface of said inner perimeter seal and a second seal bead on a second surface of said inner perimeter seal, said second surface facing in a direction opposite to said first surface, said inner perimeter seal being adapted to be inserted between the first and second members of the inner assembly.

14. The seal according to claim 13, wherein said outer perimeter seal is circular.

15. The seal according to claim 14, wherein said inner perimeter seal is rectangular.

16. The seal according to claim 13, wherein said inner perimeter seal is rectangular.

17. The seal according to claim 13, wherein said outer perimeter seal is generally rectangular.

18. The seal according to claim 17, wherein said inner perimeter seal is generally rectangular.

19. The seal according to claim 13, wherein said first seal bead of said outer perimeter seal extends radially outward.

20. The seal according to claim 19, wherein said second seal bead of said outer perimeter seal extends radially outward.

21. The seal according to claim 19, wherein said second seal bead of said outer perimeter seal extends axially in a direction of said first seal bead.

22. The seal according to claim 13, wherein said reinforcing insert of said inner perimeter seal is molded into said inner perimeter seal.

23. The seal according to claim 13, wherein said flexible diaphragm portion extends axially from said reinforcing insert of said outer perimeter seal.

24. The seal according to claim 23, wherein said flexible diaphragm portion forms a fold-over portion wherein said flexible diaphragm portion radially overlaps itself between said outer perimeter seal and said inner perimeter seal.

25. A seal for sealing between an outer perimeter opening having upper and lower edges and an inner assembly having first and second members, comprising:
an outer perimeter seal including a reinforcing insert molded therein, said reinforcing insert generally having a shape of the outer perimeter opening, said outer perimeter seal including a first seal bead at a first axial end and a second seal bead at a second axial end;
a flexible diaphragm portion extending radially inward from said outer perimeter seal; and
an inner perimeter seal connected to a radially inner end of said flexible diaphragm portion, said inner perimeter seal including a first seal bead on a first surface of said inner perimeter seal and a second seal bead on a second surface of said inner perimeter seal, said second surface facing in a direction opposite to said first surface, said inner perimeter seal being adapted to be inserted between the first and second members of the inner assembly;
wherein said flexible diaphragm portion forms a fold-over portion wherein said flexible diaphragm portion radially overlaps itself between said outer perimeter seal and said inner perimeter seal.
